(19) United States
(12) Patent Application Publication
(10) Pub. No.: US 2018/0083399 A1
(43) Pub. Date: Mar. 22, 2018

(54) ELECTRICAL CONNECTOR

(71) Applicant: LOTES CO., LTD., Keelung (TW)

(72) Inventors: Wen Chang Chang, Keelung (TW); Quan Long, Keelung (TW); Jin Zhu Wang, Keelung (TW)

(21) Appl. No.: 15/684,119

(22) Filed: Aug. 23, 2017

Related U.S. Application Data
(60) Provisional application No. 62/381,117, filed on Aug. 30, 2016.

(30) Foreign Application Priority Data
Jul. 6, 2017 (CN) 201710546861.3

(51) Int. Cl. H01R 24/50; H01R 13/66; H01R 13/646

(52) U.S. Cl. CPC H01R 24/50; H01R 13/646; H01R 13/665

(57) ABSTRACT

An electrical connector includes a terminal module, which includes a first terminal and a positioning seat. The first terminal has a first connecting portion, a first soldering portion extending from a rear side of the first connecting portion, and a first contact portion extending forward from the first connecting portion. The first connecting portion includes a first retaining portion connected to the first soldering portion and retained into the positioning seat. A mold core cavity is concavely formed upward from a bottom surface of the positioning seat. A second terminal is located above the first terminal. An insulating body is formed outside the terminal module and the second terminal by injection-molding. A first mold core hole is concavely formed upward from a bottom surface of the insulating body, and a second mold core hole is concavely formed downward from a top surface of the insulating body.

### CROSS-REFERENCE TO RELATED APPLICATION

This application claims priority to and the benefit of, pursuant to 35 U.S.C. § 119(e), U.S. provisional patent application Ser. No. 62/381,117, filed Aug. 30, 2016. The entire content of the above identified application is incorporated herein by reference.

### FIELD OF THE INVENTION

The present invention relates to an electrical connector, and more particularly to an electrical connector provided with a mold core cavity and a mold core hole.

### BACKGROUND OF THE INVENTION

The background description provided herein is for the purpose of generally presenting the context of the disclosure. Work of the presently named inventors, to the extent it is described in this background section, as well as aspects of the description that may not otherwise qualify as prior art at the time of filing, are neither expressly nor impliedly admitted as prior art against the present disclosure.

An existing electrical connector generally includes a first terminal, a second terminal and a middle shielding sheet for resisting high-frequency interference. A manufacturing process in the prior art includes: injection-molding the first terminal and a plastic body to form a first terminal module, injection-molding the second terminal and another plastic body to form a second terminal module, inserting the middle shielding sheet between the first terminal module and the second terminal module, and then fastening the middle shielding sheet, the first terminal module and the second terminal module. The assembly method is prone to forming an assembly clearance. In a subsequent electrical connector, a first terminal module is formed by injection-molding a first terminal, a middle shielding sheet and a plastic body; a second terminal is fixed to the first terminal module; and then an insulating body is further formed outside the first terminal module and the second terminal by injection-molding. Although this method solves the problem of the assembly clearance, the plastic body of the first terminal module may be prone to expansive deformation during the second injection-molding process, so as to cause deviation of soldering pins of the first terminal.

Therefore, it is necessary to design a novel electrical connector, so as to overcome the foregoing problem.

### SUMMARY OF THE INVENTION

The present invention is directed to an electrical connector having soldering pins that do not easily deviate, and is high in positioning accuracy.

To achieve the foregoing objective, one aspect of the present invention is related to an electrical connector, which includes: a terminal module, comprising a first terminal and a positioning seat, the first terminal having a first connecting portion, a first soldering portion extending from a rear side of the first connecting portion, and a first contact portion extending forward from the first connecting portion, wherein the first connecting portion comprises a first retaining portion connected to the first soldering portion, the first retaining portion is retained into the positioning seat, and at least one mold core cavity is concavely formed upward from a bottom surface of the positioning seat; a second terminal, located above the first terminal; and an insulating body, formed outside the terminal module and the second terminal by injection-molding, wherein a first mold core hole is concavely formed upward from a bottom surface of the insulating body, a second mold core hole is concavely formed downward from a top surface of the insulating body, the first mold core hole extends into the mold core cavity, and the second mold core hole extends to a top surface of the positioning seat.

In one embodiment, the at least one mold core cavity comprises a plurality of mold core cavities located at a front end and a rear end of the positioning seat respectively, the mold core cavity located at the front end of the positioning seat runs through the front end face of the positioning seat, and the mold core cavity located at the rear end of the positioning seat runs through the rear end face of the positioning seat.

In one embodiment, the at least one mold core cavity comprises three mold core cavities arranged to form an isosceles triangle.

In one embodiment, the insulating body includes a base portion and a tongue extending forward from the base portion, the first contact portion is exposed from a bottom surface of the tongue, the first connecting portion is retained into the base portion and the tongue, the first soldering portion extends out of a bottom surface of the base portion, and the positioning seat is located in the base portion.

In one embodiment, the second terminal includes a second connecting portion, a second contact portion extending forward from the second connecting portion, and a second soldering portion extending backward from the second connecting portion, wherein the second contact portion is exposed from an upper surface of the tongue, the second connecting portion is retained into the base portion and the tongue, and the second soldering portion extends out of the bottom surface of the base portion.

In one embodiment, the first mold core hole and the second mold core hole are concavely formed from the bottom surface and an upper surface of the base portion respectively.

In one embodiment, the first connecting portion comprises a first extending portion connected to the first contact portion and the first retaining portion, the terminal module includes an insulating block and a middle shielding sheet, the middle shielding sheet is located between the first terminal and the second terminal, and the insulating block is formed outside the first contact portion, the first extending portion and the middle shielding sheet by injection-molding.

In one embodiment, two protruding blocks are provided at two sides of the positioning seat, two grooves are provided at two sides of a rear end of the insulating block, and the protruding blocks are fastened into the grooves.

In one embodiment, the insulating block is provided with a clamping groove, and the second terminal is clamped in the clamping groove.

In one embodiment, a first inclined guide surface is provided in the mold core cavity.

In one embodiment, a second inclined guide surface is provided in the first mold core hole.

In one embodiment, the positioning seat is formed outside the first retaining portion by injection-molding.

Compared with the related art, in the electrical connector according to certain embodiments of the present invention, the mold core cavities are provided on the positioning seat retaining the first retaining portion, and the insulating body is formed outside the terminal module and the second terminal by injection-molding. The insulating body is provided with the first mold core hole and the second mold core hole. Three mold core cavities on the bottom surface of the positioning seat allow insertion of mold core columns during injection-molding of the insulating body, so that the mold core columns can limit the positioning seat in front, back, left and right directions and can clamp and limit the positioning seat up and down, thus preventing deviation of soldering pins of the terminals caused by expansive deformation of plastics of the positioning seat, and providing the positioning accuracy.

These and other aspects of the present invention will become apparent from the following description of the preferred embodiment taken in conjunction with the following drawings, although variations and modifications therein may be effected without departing from the spirit and scope of the novel concepts of the disclosure.

### BRIEF DESCRIPTION OF THE DRAWINGS

The accompanying drawings illustrate one or more embodiments of the invention and together with the written description, serve to explain the principles of the invention. Wherever possible, the same reference numbers are used throughout the drawings to refer to the same or like elements of an embodiment.

FIG. 1 is a three-dimensional exploded view of an electrical connector according to one embodiment of the present invention.

FIG. 2 is a three-dimensional exploded view of an electrical connector from another angle according to one embodiment of the present invention.

FIG. 3 is a three-dimensional view of a first molding process of an electrical connector according to one embodiment of the present invention.

FIG. 4 is a three-dimensional view of a second molding process of an electrical connector according to one embodiment of the present invention.

FIG. 5 is a three-dimensional view of a third molding process of an electrical connector according to one embodiment of the present invention.

FIG. 6 is a partial three-dimensional assembled view of an electrical connector according to one embodiment of the present invention.

FIG. 7 is a sectional view of an electrical connector along line A-A in FIG. 6 according to one embodiment of the present invention.

FIG. 8 is a sectional view of an electrical connector according to one embodiment of the present invention.

FIG. 9 is a partial three-dimensional assembled view of an electrical connector from another angle according to one embodiment of the present invention.

FIG. 10 is a partial three-dimensional assembled view of an electrical connector in FIG. 9 from another angle according to one embodiment of the present invention.

FIG. 11 is a sectional view of an electrical connector from another angle according to one embodiment of the present invention.

### DETAILED DESCRIPTION OF THE INVENTION

The present invention is more particularly described in the following examples that are intended as illustrative only since numerous modifications and variations therein will be apparent to those skilled in the art. Various embodiments of the invention are now described in detail. Referring to the drawings, like numbers indicate like components throughout the views. As used in the description herein and throughout the claims that follow, the meaning of “a”, “an”, and “the” includes plural reference unless the context clearly dictates otherwise. Also, as used in the description herein and throughout the claims that follow, the meaning of “in” includes “in” and “on” unless the context clearly dictates otherwise. Moreover, titles or subtitles may be used in the specification for the convenience of a reader, which shall have no influence on the scope of the present invention.

The terms used in this specification generally have their ordinary meanings in the art, within the context of the disclosure, and in the specific context where each term is used. Certain terms that are used to describe the disclosure are discussed below, or elsewhere in the specification, to provide additional guidance to the practitioner regarding the description of the disclosure. For convenience, certain terms may be highlighted, for example using italics and/or quotation marks. The use of highlighting has no influence on the scope and meaning of a term; the scope and meaning of a term is the same, in the same context, whether or not it is highlighted. It will be appreciated that same thing can be said in more than one way. Consequently, alternative language and synonyms may be used for any one or more of the terms discussed herein, nor is any special significance to be placed upon whether or not a term is elaborated or discussed herein. Synonyms for certain terms are provided. A recital of one or more synonyms does not exclude the use of other synonyms. The use of examples anywhere in this specification including examples of any terms discussed herein is illustrative only, and in no way limits the scope and meaning of the disclosure or of any exemplified term. Likewise, the disclosure is not limited to various embodiments given in this specification.

Unless otherwise defined, all technical and scientific terms used herein have the same meaning as commonly understood by one of ordinary skill in the art to which this disclosure pertains. In the case of conflict, the present document, including definitions will control.

It will be understood that when an element is referred to as being “on” another element, it can be directly on the other element or intervening elements may be present therebetween. In contrast, when an element is referred to as being “directly on” another element, there are no intervening elements present. As used herein, the term “and/or” includes any and all combinations of one or more of the associated listed items.

Furthermore, relative terms, such as “lower” or “bottom” and “upper” or “top,” may be used herein to describe one element's relationship to another element as illustrated in the Figures. It will be understood that relative terms are intended to encompass different orientations of the device in addition to the orientation depicted in the Figures. For example, if the device in one of the figures is turned over, elements described as being on the “lower” side of other elements would then be oriented on “upper” sides of the other elements. The exemplary term “lower”, can therefore, encompasses both an orientation of “lower” and “upper,” depending of the particular orientation of the figure. Similarly, if the device in one of the figures is turned over, elements described as “below” or “beneath” other elements would then be oriented “above” the other elements. The exemplary terms “below” or “beneath” can, therefore, encompass both an orientation of above and below.

As used herein, “around”, “about” or “approximately” shall generally mean within 20 percent, preferably within 10 percent, and more preferably within 5 percent of a given value or range. Numerical quantities given herein are approximate, meaning that the term “around”, “about” or “approximately” can be inferred if not expressly stated.

As used herein, “plurality” and/or “multiple” means two or more.

As used herein, the terms “comprising”, “including”, “carrying”, “having”, “containing”, “involving”, and the like are to be understood to be open-ended, i.e., to mean including but not limited to.

As used herein, the phrase at least one of A, B, and C should be construed to mean a logical (A or B or C), using a non-exclusive logical OR. It should be understood that one or more steps within a method may be executed in different order (or concurrently) without altering the principles of the present disclosure.

It will be understood that, although the terms first, second, third, etc. may be used herein to describe various elements, components, regions, layers and/or sections, these elements, components, regions, layers and/or sections should not be limited by these terms. These terms are only used to distinguish one element, component, region, layer or section from another element, component, region, layer or section. Thus, a first element, component, region, layer or section discussed below can be termed a second element, component, region, layer or section without departing from the teachings of the present invention.

It will be understood that when an element is referred to as being “on”, “attached” to, “connected” to, “coupled” with, “contacting”, etc., another element, it can be directly on, attached to, connected to, coupled with or contacting the other element or intervening elements may also be present. In contrast, when an element is referred to as being, for example, “directly on”, “directly attached” to, “directly connected” to, “directly coupled” with or “directly contacting” another element, there are no intervening elements present. It will also be appreciated by those of skill in the art that references to a structure or feature that is disposed “adjacent” to another feature may have portions that overlap or underlie the adjacent feature.

Furthermore, relative terms, such as “lower” or “bottom” and “upper” or “top”, may be used herein to describe one element's relationship to another element as illustrated in the figures. It will be understood that relative terms are intended to encompass different orientations of the device in addition to the orientation shown in the figures. For example, if the device in one of the figures is turned over, elements described as being on the “lower” side of other elements would then be oriented on the “upper” sides of the other elements. The exemplary term “lower” can, therefore, encompass both an orientation of lower and upper, depending on the particular orientation of the figure. Similarly, if the device in one of the figures is turned over, elements described as “below” or “beneath” other elements would then be oriented “above” the other elements. The exemplary terms “below” or “beneath” can, therefore, encompass both an orientation of above and below.

As used herein, the abbreviated term “USB” refers to the universal serial bus.

For convenience of better understanding objectives, structures, features and efficacies of the present invention, the present invention is further described with reference to accompanying drawings and specific implementation manners.

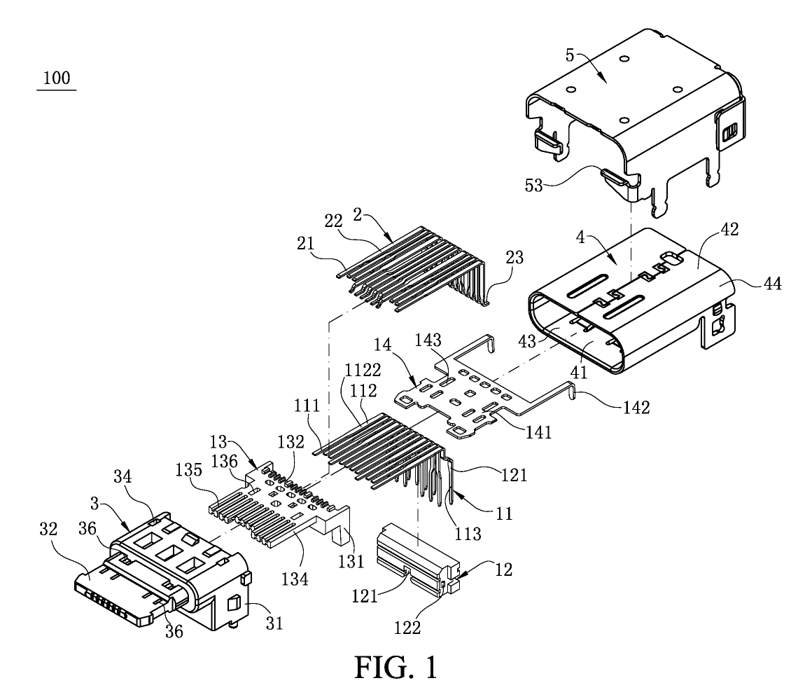

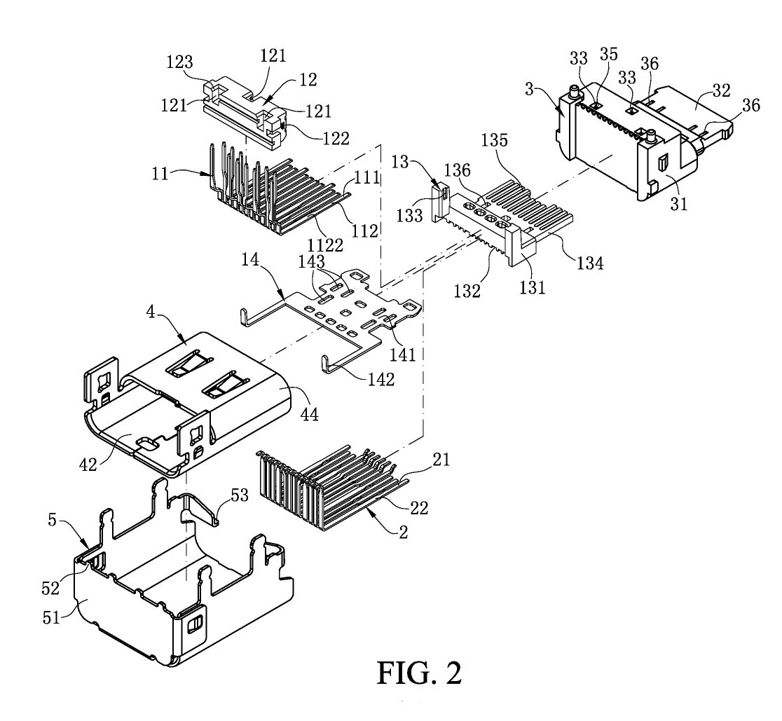

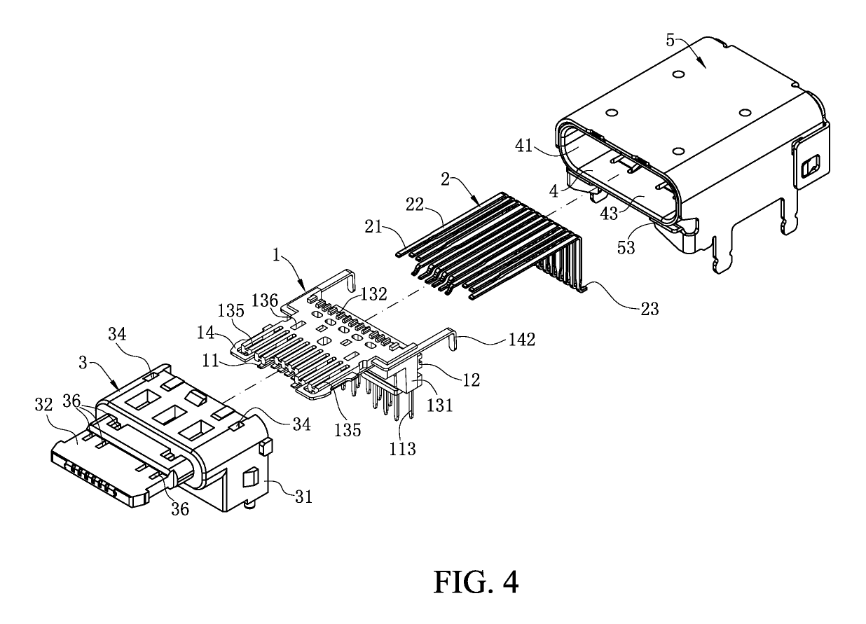

As shown in FIG. 1, FIG. 2 and FIG. 4, as the most preferable embodiment, an electrical connector 100 of the present invention is used for being mounted on a circuit board (not shown). The electrical connector 100 includes a terminal module 1, a second terminal 2 and an insulating body 3. The insulating body 3 is formed outside the terminal module 1 and the second terminal 2 by injection-molding. An inner metal case 4 is disposed at the outer side of the insulating body 3 in a framing manner, and an outer metal case 5 is disposed at the outer side of the inner metal case 4 in a framing manner.

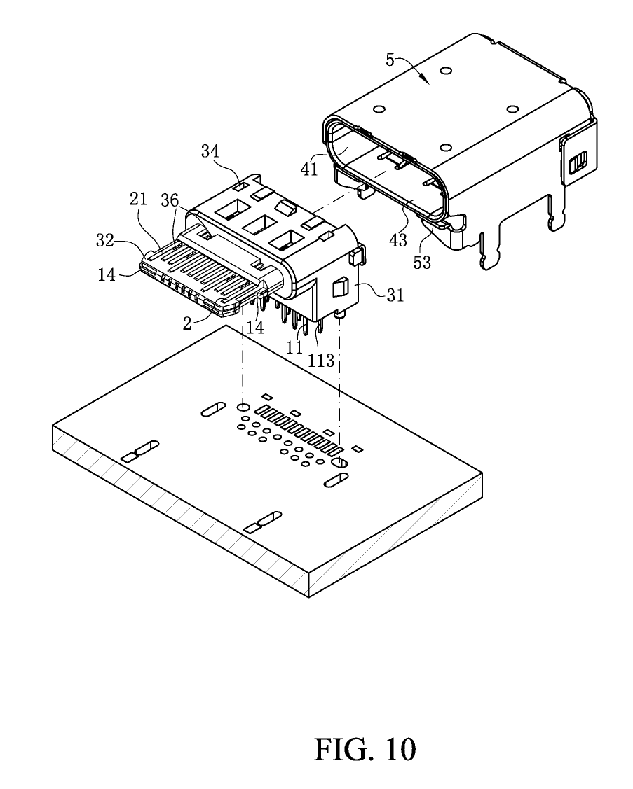

As shown in FIG. 1, FIG. 2 and FIG. 10, the inner metal case 4 is formed by enclosing a mating cavity 41 arranged 180 degrees symmetrically to wrap the insulating body 3. The inner metal case 4 includes a top wall 42, a bottom wall 43 and two side walls 44 connecting the top wall 42 and the bottom wall 43. The outer metal case 5 wraps the top wall 42 and the side walls 44 of the inner metal case 4. The outer metal case 5 has a rear cover 51 shielding a rear end face of the insulating body 3. Four grounding pins 52 extend down vertically from the rear cover 51, and are used for being soldered to a grounding path of the circuit board. The outer metal case 5 is further provided with two supporting pins 53, supporting the bottom wall 43 of the inner metal case 4 upward.

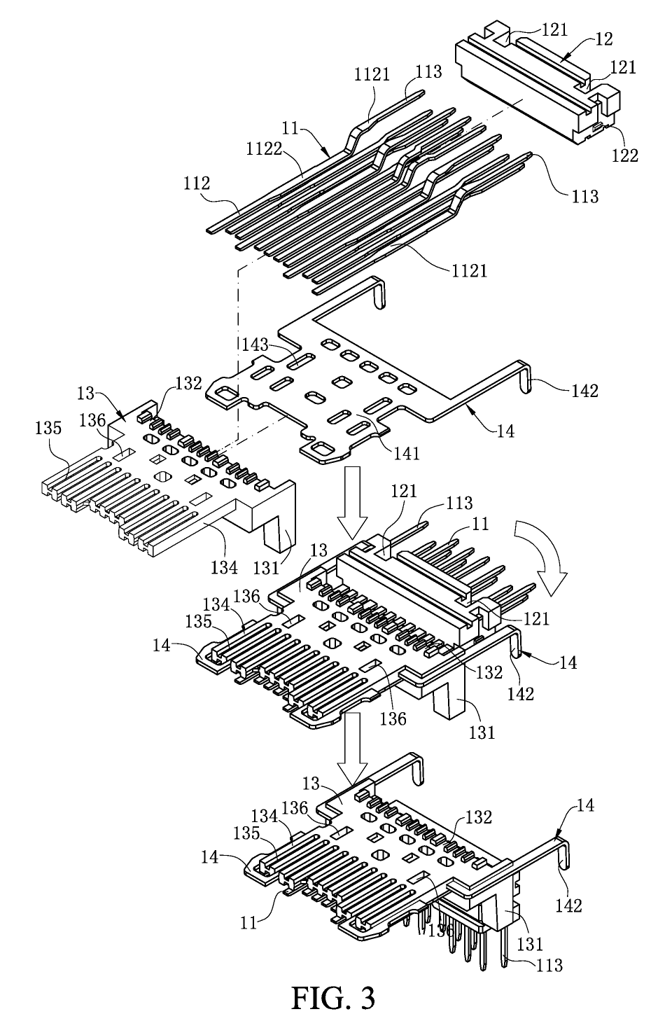

As shown in FIG. 1, FIG. 2 and FIG. 3, the terminal module 1 includes a first terminal 11, a positioning seat 12, an insulating block 13 and a middle shielding sheet 14. The first terminal 11 includes a first contact portion 111, a first soldering portion 113, and a first connecting portion 112 connected between the first contact portion 111 and the first soldering portion 113. The first connecting portion 112 includes a first retaining portion 1121 and a first extending portion 1122 bending forward from the first retaining portion 1121. The first retaining portion 1121 is connected to the first soldering portion 113, and the first extending portion 1122 is connected to the first contact portion 111. The first retaining portion 1121 is retained into the positioning seat 12. In the present embodiment, the positioning seat 12 is formed outside the first retaining portion 1121 by injection-molding, and the insulating block 13 is formed outside the first contact portion 111, the first extending portion 1122 and the middle shielding sheet 14 by injection-molding. In other embodiments, it is not limited thereto.

Each of the left and right sides of the positioning seat 12 is provided with a protruding block 122. Three mold core cavities 121 are concavely formed upward from a bottom surface of the positioning seat 12. One of the mold core cavities 121 is located at a front end of the bottom surface of the positioning seat 12, and the other two mold core cavities 121 are located at a rear end of the bottom surface of the positioning seat 12. The mold core cavity 121 located at the front end of the positioning seat 12 runs through the front end surface of the positioning seat 12, and each of the mold core cavities 121 located at the rear end of the positioning seat 12 runs through the rear end surface of the positioning seat 12. A first inclined guide surface 123 is provided in each of the mold core cavities 121. The three mold core cavities 121 are arranged to form an isosceles triangle.

The insulating block 13 includes a main body portion 131 and a tongue piece 134 extending forward horizontally from an upper end of the main body portion 131. A top surface of the main body portion 131 is provided with multiple clamping grooves 132, and each of the left and right sides of the main body portion 131 is provided with a groove 133. The protruding blocks 122 of the positioning seat 12 are fastened into the grooves 133, such that the positioning seat 12 is fixed to the insulating block 13. The top and bottom surfaces of the tongue piece 134 are provided with multiple flow guide slots 135 respectively. The tongue piece 134 is further provided with multiple penetration holes 136 running through the top and bottom surfaces of the tongue piece 134.

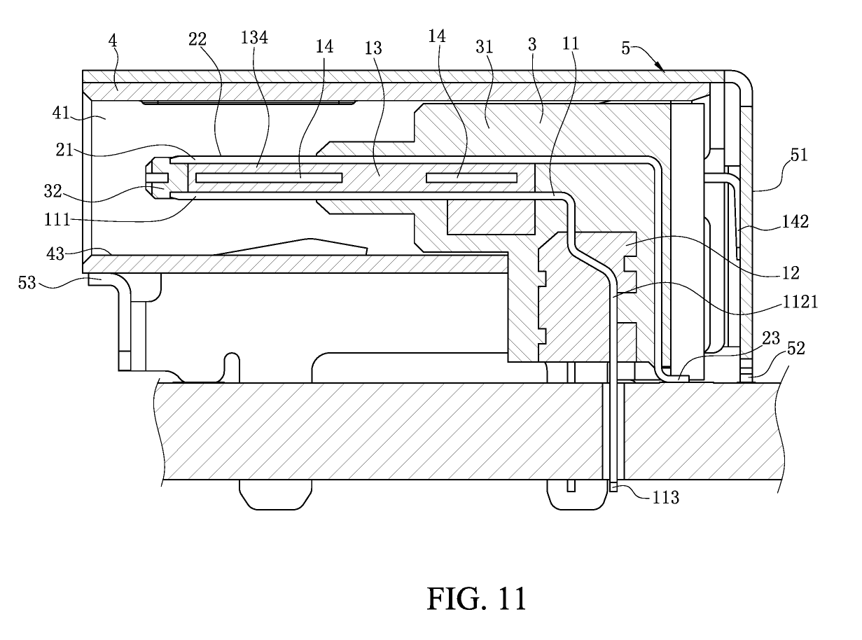

The middle shielding sheet 14 includes a flat plate portion 141 and two pins 142 extending backward and then bending downward from the flat plate portion 141. As shown in FIG. 11, the pins 142 abut the rear cover 51 of the outer metal case 5. The flat plate portion 141 is provided with multiple through holes 143 communicated with the penetration holes 136, for convenience of cutting off the material bridges of the terminals.

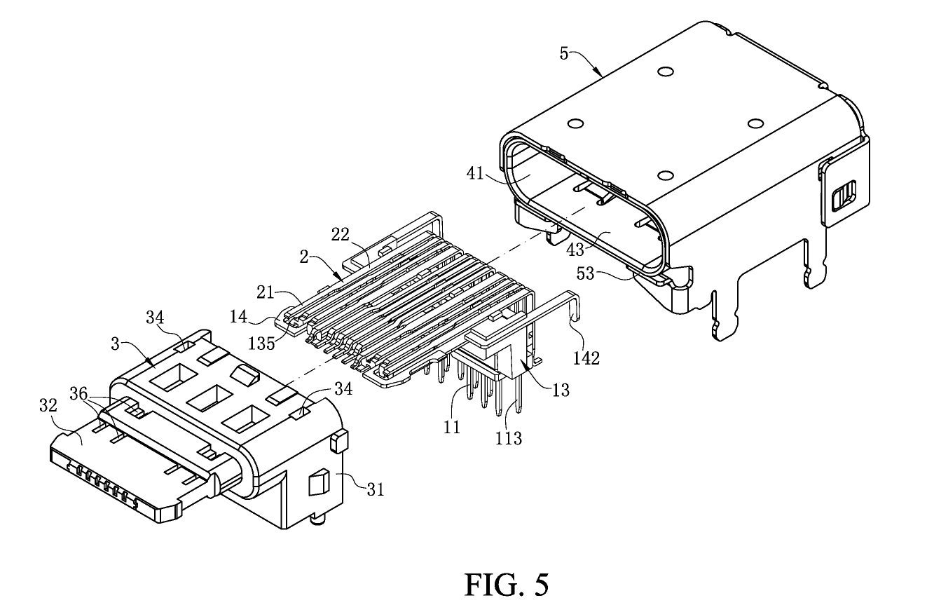

As shown in FIG. 4 and FIG. 5, the second terminal 2 is located above the first terminal 11. The middle shielding sheet 14 is located between the first terminal 11 and the second terminal 2 for shielding signal interference between the second terminal 2 and the first terminal 11, thereby enhancing the shielding effect of the electrical connector 100. The second terminal 2 is correspondingly engaged and fixed to the clamping grooves 132. The second terminal 2 includes a second contact portion 21, a second soldering portion 23, and a second connecting portion 22 connected to the second contact portion 21 and the second soldering portion 23.

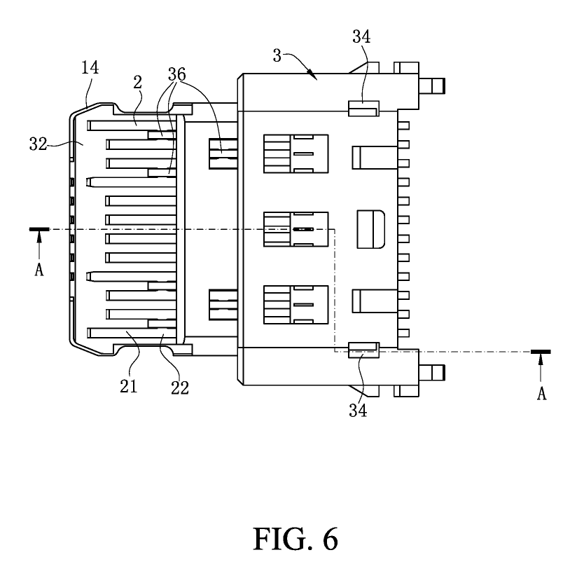

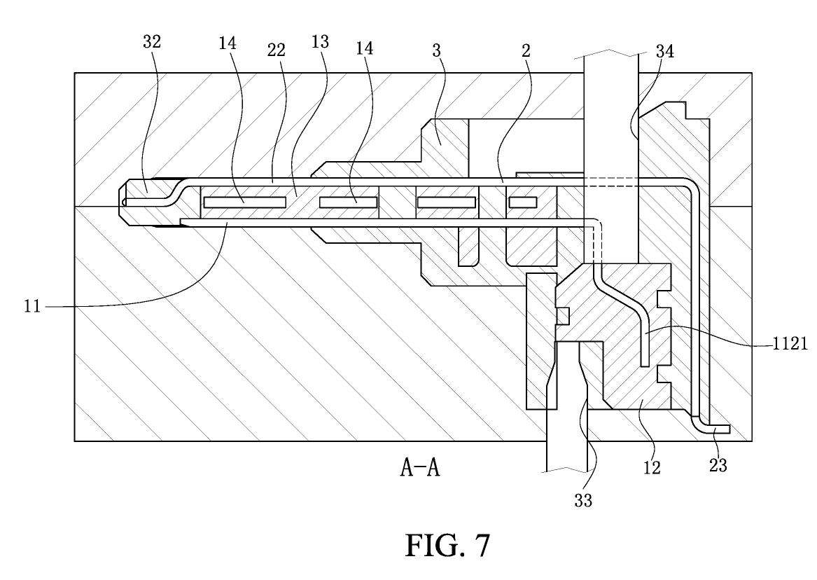

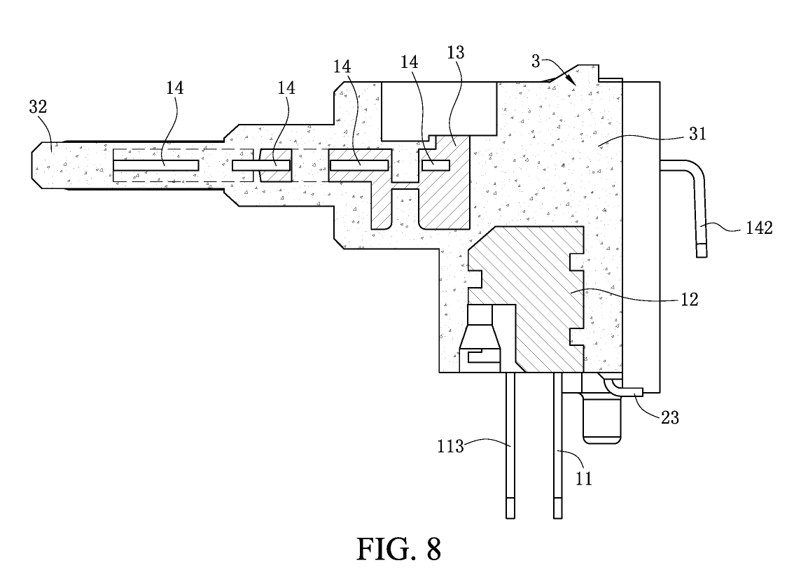

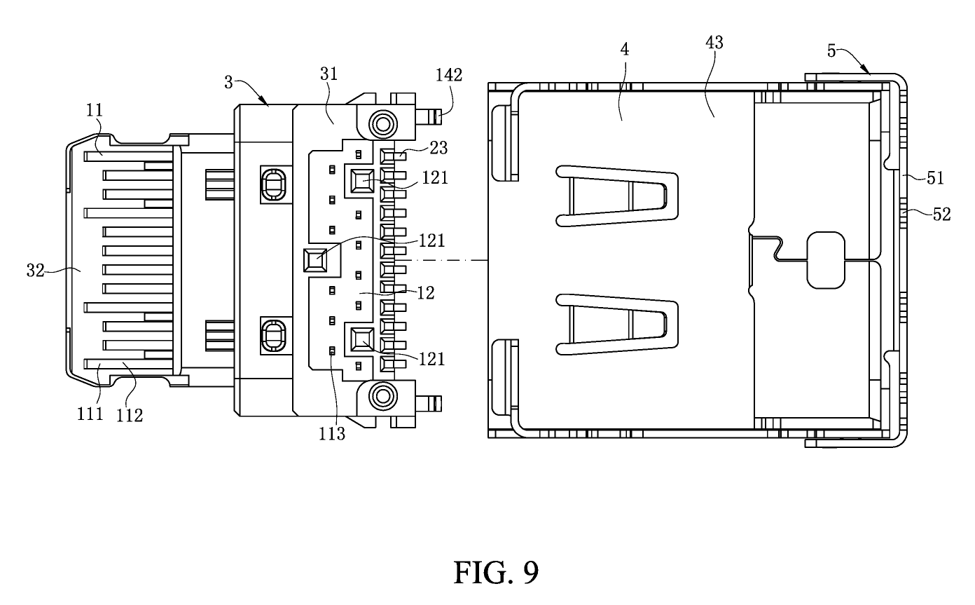

As shown in FIG. 7, FIG. 8 and FIG. 10, the insulating body 3 is formed outside the terminal module 1 and the second terminal 2 by injection-molding. The insulating body 3 includes a base portion 31 and a tongue 32 extending forward from the base portion 31. The base portion 31 is relatively wide and large, while the tongue 32 is relatively narrow and long. Three first mold core holes 33 are concavely formed upward from a bottom surface of the base portion 31. Two second mold core holes 34 are concavely formed downward from a top surface of the base portion 31. One of the first mold core holes 33 is located at a front end of the bottom surface of the base portion 31, and the other two first mold core holes 33 are located at a rear end of the bottom surface of the base portion 31, such that the three first mold core holes 33 are arranged to form an isosceles triangle. As shown in FIG. 6 and FIG. 9, each of the second mold core holes 34 extends to the top surface of the positioning seat 12, and each of the first mold core holes 33 extends into the mold core cavity 121. The tongue 32 is provided with multiple through slots 36, which run through the top and bottom surfaces of the tongue 32. The through slots 36 are communicated with the penetration holes 136 and the through holes 143. A second inclined guide surface 35 is provided in each of the first mold core holes 33.

As shown in FIG. 6, FIG. 9 and FIG. 10, both the second terminal 2 and the first terminal 11 are retained into the insulating body 3 and arranged in an upper row and a lower row. The middle shielding sheet 14 is also retained into the insulating body 3. The first contact portion 111 is exposed from the bottom surface of the tongue 32. The first soldering portion 113 protrudes out of the bottom surface of the base portion 31. The first connecting portion 112 is retained into the base portion 31 and the tongue 32. The second contact portion 21 is exposed from the upper surface of the tongue 32. The second soldering portion 23 protrudes out of the bottom surface of the base portion 31. The second connecting portion 22 is retained into the base portion 31 and the tongue 32. The positioning seat 12 is located in the base portion 31. The tongue piece 134 is located in the tongue 32. The main body portion 131 is located in the base portion 31. The flow guide slots 135 on the tongue piece 134 are used as plastic flowing passages during injection-molding of the insulating body 3, so as to facilitate plastic filling. The second connecting portion 22 is correspondingly engaged and fixed to the clamping grooves 132 of the insulating block 13.

As shown in FIG. 1, FIG. 2 and FIG. 10, the first terminal 11 and the second terminal 2 totally include four ground terminals located in an upper row and a lower row respectively, and both the two outermost terminals in the first terminal 11 and the second terminal 2 are the ground terminals. In the present embodiment, the first terminal 11 and the second terminal 2 each includes 12 terminals, and the 12 terminals located in the upper row and the 12 terminals located in the lower row are in a left-and-right opposite arrangement order and in a vertically symmetrical arrangement mode, and the transmitted signals are the same. The arrangement order from left to right of the multiple terminals in the upper row is sequentially a ground terminal (GND), a pair of differential signal high-speed transmission terminals (TX1+, TX1−, i.e. a pair of USB 3.0 terminals), a power terminal (Vbus), a reserved terminal (CC1), a pair of USB 2.0 differential terminals (Dp1, Dn1), a reserved terminal (SBU1), a power terminal (Vbus), a pair of differential signal high-speed receiving terminals (RX2+, RX2−), and a ground terminal (GND). That is, the two terminals at the outermost side of the multiple terminals in the upper row are both the ground terminals. The arrangement order from right to left of the multiple terminals in the lower row is sequentially a ground terminal (GND), a pair of differential signal high-speed transmission terminals (TX2+, TX2−, i.e. a pair of USB 3.0 terminals, a power terminal (Vbus), a reserved terminal (CC2), a pair of USB 2.0 differential terminals (Dp2, Dn2), a reserved terminal (SBU2), a power terminal (Vbus), a pair of differential signal high-speed receiving terminals (RX1+, RX1−), and a ground terminal (GND). That is, the two terminals at the outermost side of the multiple terminals in the lower row are both the ground terminals. The multiple terminals located in the upper and lower rows on the insulating body 3 are arranged in such a way that the electrical connector 100 can be plugged in forwardly and reversibly.

As shown in FIG. 7 and FIG. 8, when the insulating body 3 is formed outside the terminal module 1 and the second terminal 2 by injection-molding, the first guide surface 123 in each of the mold core cavities 121 can guide a corresponding mold core column to be inserted into the mold core cavity 121. Three mold core columns located below the positioning seat 12 can be inserted into the mold core cavities 121 respectively, thereby limiting the positioning seat 12 in front, back, left and right directions, and pushing up against and limiting the positioning seat 12. The mold core columns located above the positioning seat 12 downward abut the top surface of the positioning seat 12, thereby preventing deviation of the first soldering portion 113 caused by expansive deformation of plastics of the positioning seat 12, and thus improving the positioning accuracy. After the plastics of the insulating body 3 are cooled, the second mold core holes 34 will be reserved on the top surface of the base portion 31, and the first mold core holes 33 will be reserved on the bottom surface of the base portion 31.

To sum up, the electrical connector 100 according to certain embodiments of the present invention has the following beneficial effects.

(1) The electrical connector 100 is provided with the mold core cavities 121 concavely formed from the bottom surface of the positioning seat 12, and the insulating body 3 is formed outside the terminal module 1 and the second terminal 2 by injection-molding. The first mold core holes 33 are provided on the bottom surface of the insulating body 3, and the second mold core holes 34 are provided on the top surface of the insulating body 3. Each of the first mold core holes 33 extends into the mold core cavities 121, and each of the second mold core holes 34 extends to the top surface of the positioning seat 12. Three mold core columns located below the positioning seat 12 are inserted into the mold core cavities 121 respectively, thereby limiting the positioning seat 12 in front, back, left and right directions, and pushing up against and limiting the positioning seat 12. The mold core columns located above the positioning seat 12 downward abut the top surface of the positioning seat 12, thereby preventing deviation of the first soldering portion 113 caused by expansive deformation of plastics of the positioning seat 12, and thus improving the positioning accuracy.

(2) When the insulating body 3 is formed outside the terminal module 1 and the second terminal 2 by injection-molding, the first guide surface 123 in each of the mold core cavities 121 can guide a corresponding mold core column to be inserted into the mold core cavity 121, thus improving the molding effect.

(3) The positioning seat 12 is formed outside the first retaining portion 1121 by injection-molding, and the mold core cavities 121 run through the front end surface and the rear end surface of the positioning seat 12 respectively, thus making it convenient for the mold core columns to clamp and limit the positioning seat 12 in a front-rear direction, and preventing deviation of the first soldering portion 113 caused by deviation of the positioning seat 12.

(4) There are three mold core cavities 121 located at the front and rear sides of the positioning seat 12 respectively, thereby well fixing and limiting the positioning seat 12.

The foregoing description of the exemplary embodiments of the invention has been presented only for the purposes of illustration and description and is not intended to be exhaustive or to limit the invention to the precise forms disclosed. Many modifications and variations are possible in light of the above teaching.

The embodiments are chosen and described in order to explain the principles of the invention and their practical application so as to activate others skilled in the art to utilize the invention and various embodiments and with various modifications as are suited to the particular use contemplated. Alternative embodiments will become apparent to those skilled in the art to which the present invention pertains without departing from its spirit and scope. Accordingly, the scope of the present invention is defined by the appended claims rather than the foregoing description and the exemplary embodiments described therein.

What is claimed is:

1. An electrical connector, comprising:
a terminal module, comprising a first terminal and a positioning seat, the first terminal having a first connecting portion, a first soldering portion extending from a rear side of the first connecting portion, and a first contact portion extending forward from the first connecting portion, wherein the first connecting portion comprises a first retaining portion connected to the first soldering portion, the first retaining portion is retained into the positioning seat, and at least one mold core cavity is concavely formed upward from a bottom surface of the positioning seat;
a second terminal, located above the first terminal; and
an insulating body, formed outside the terminal module and the second terminal by injection-molding, wherein a first mold core hole is concavely formed upward from a bottom surface of the insulating body, a second mold core hole is concavely formed downward from a top surface of the insulating body, the first mold core hole extends into the mold core cavity, and the second mold core hole extends to a top surface of the positioning seat.

2. The electrical connector of claim 1, wherein the at least one mold core cavity comprises a plurality of mold core cavities located at a front end and a rear end of the positioning seat respectively, the mold core cavity located at the front end of the positioning seat runs through the front end face of the positioning seat, and the mold core cavity located at the rear end of the positioning seat runs through the rear end face of the positioning seat.

3. The electrical connector of claim 1, wherein the at least one mold core cavity comprises three mold core cavities arranged to form an isosceles triangle.

4. The electrical connector of claim 1, wherein the insulating body comprises a base portion and a tongue extending forward from the base portion, the first contact portion is exposed from a bottom surface of the tongue, the first connecting portion is retained into the base portion and the tongue, the first soldering portion extends out of a bottom surface of the base portion, and the positioning seat is located in the base portion.

5. The electrical connector of claim 4, wherein the second terminal comprises a second connecting portion, a second contact portion extending forward from the second connecting portion, and a second soldering portion extending backward from the second connecting portion, wherein the second contact portion is exposed from a top surface of the tongue, the second connecting portion is retained into the base portion and the tongue, and the second soldering portion extends out of the bottom surface of the base portion.

6. The electrical connector of claim 4, wherein the first mold core hole and the second mold core hole are concavely formed from the bottom surface and an upper surface of the base portion respectively.

7. The electrical connector of claim 1, wherein:
the first connecting portion comprises a first extending portion connected to the first contact portion and the first retaining portion,
the terminal module comprises an insulating block and a middle shielding sheet,
the middle shielding sheet is located between the first terminal and the second terminal, and
the insulating block is formed outside the first contact portion, the first extending portion and the middle shielding sheet by injection-molding.

8. The electrical connector of claim 7, wherein two protruding blocks are provided at two sides of the positioning seat, two grooves are provided at two sides of a rear end of the insulating block, and the protruding blocks are fastened into the grooves.

9. The electrical connector of claim 7, wherein the insulating block is provided with a clamping groove, and the second terminal is clamped in the clamping groove.

10. The electrical connector of claim 1, wherein a first inclined guide surface is provided in the mold core cavity.

11. The electrical connector of claim 1, wherein a second inclined guide surface is provided in the first mold core hole.

12. The electrical connector of claim 1, wherein the positioning seat is formed outside the first retaining portion by injection-molding.
